(19) United States
(12) Patent Application Publication
(10) Pub. No.: US 2025/0084884 A1
(43) Pub. Date: Mar. 13, 2025

(54) FASTENING COLLARS, MULTI-PIECE FASTENERS, AND METHODS FOR FASTENING

(71) Applicant: HOWMET AEROSPACE INC., Pittsburgh, PA (US)

(72) Inventor: Arnaud BRUNET, Bezu-Saint Eloi, Eure (FR)

(21) Appl. No.: 18/580,242

(22) PCT Filed: Aug. 16, 2022
(86) PCT No.: PCT/IB2022/000485

§ 371 Date: Jan. 18, 2024

Related U.S. Application Data
(60) Provisional application No. 63/234,817, filed on Aug. 19, 2021.

(30) Foreign Application Priority Data
Aug. 19, 2021 (FR) FR2108785

(51) Int. Cl. F16B 19/05

(52) U.S. Cl. CPC F16B 19/05

(57) ABSTRACT

The present disclosure relates to fastening collars, multi-piece fasteners, and methods for fastening. A fastening collar comprises a first collar end, a second collar end, and an elongate portion intermediate the first collar end and the second collar end and defining a longitudinal axis of the fastening collar. The elongate portion comprises an external collar surface, an inner collar surface defining a collar cavity, and a groove on at least one of the external collar surface and inner collar surface. The groove extends a first distance along the longitudinal axis.

### FIELD OF USE

The present disclosure relates to fastening collars, multi-piece fasteners, and methods for fastening.

### BACKGROUND

Vehicle frames, storage racks, solar panel sub-structures, aircraft parts, and other structures can include numerous mechanical fasteners. For example, a mechanical fastener can be installed in a bore of a structural component to secure parts together. Properly installing a mechanical fastener into a bore may present challenges.

### SUMMARY

According to one non-limiting aspect of the present disclosure, a fastening collar comprises a first collar end, a second collar end, and an elongate portion intermediate the first collar end and the second collar end and defining a longitudinal axis of the fastening collar. The elongate portion comprises an external collar surface, an inner collar surface defining a collar cavity, and a groove on at least one of the external collar surface and inner collar surface. The groove extends a first distance along the longitudinal axis.

According to another non-limiting aspect of the present disclosure, a multi-piece fastener is provided. The multi-piece fastener comprises a fastening collar and a pin. The fastening collar comprises a first collar end, a second collar end, and an elongate portion intermediate the first collar end and the second collar end and defining a longitudinal axis of the fastening collar. The elongate portion comprises an external collar surface, an inner collar surface defining a collar cavity, and a groove on at least one of the external collar surface and inner collar surface. The groove extends a first distance along the longitudinal axis. The pin is configured to be at least partially received in the collar cavity of the fastening collar.

According to yet another non-limiting aspect of the present disclosure, a method for fastening is provided. The method comprises providing a multi-piece fastener. The multi-piece fastener comprises a fastening collar and a pin. The fastening collar comprises a first collar end, a second collar end, and an elongate portion intermediate the first collar end and the second collar end and defining a longitudinal axis of the fastening collar. The elongate portion comprises an external collar surface, an inner collar surface defining a collar cavity, and a groove on at least one of the external collar surface and the inner collar surface. The groove extends a first distance along the longitudinal axis. The pin comprises a first pin end and a shank comprising a generally smooth region. The pin is configured to be at least partially received in the collar cavity of the fastening collar. The method comprises inserting the first pin end of the pin into a bore of a structure. The elongate portion of the fastening collar is forcibly contacted with a contact surface of an installation tool, thereby forcibly contacting the structure with the second collar end of the fastening collar and deforming the elongate portion onto the shank of the pin, including deforming the groove onto the generally smooth region of the shank.

It will be understood that the inventions disclosed and described in this specification are not limited to the aspects summarized in this Summary. The reader will appreciate the foregoing details, as well as others, upon considering the following detailed description of various non-limiting and non-exhaustive aspects according to this specification.

### BRIEF DESCRIPTION OF THE DRAWINGS

The features and advantages of the examples, and the manner of attaining them, will become more apparent, and the examples will be better understood, by reference to the following description taken in conjunction with the accompanying drawings, wherein:

FIG. 1 is side view of a non-limiting embodiment of a fastening collar according to the present disclosure;

FIG. 2 is a cross-sectional side view of the fastening collar of FIG. 1;

FIG. 3 is a partial cross-sectional side view of a non-limiting embodiment of a multi-piece fastener according to the present disclosure;

FIG. 4A is a partial cross-sectional side view of non-limiting embodiments of a multi-piece fastener disposed in a structure and an installation tool in a first configuration;

FIG. 4B is a cross-sectional side view of the multi-piece fastener in the structure and the installation tool of FIG. 4A in a second configuration; and

FIG. 5 is a flow chart of a non-limiting embodiment of a method for fastening according to the present disclosure.

Corresponding reference characters indicate corresponding parts throughout the several views. The exemplifications set out herein illustrate certain non-limiting embodiments, in one form, and such exemplifications are not to be construed as limiting the scope of the appended claims in any manner.

### DETAILED DESCRIPTION OF NON-LIMITING EMBODIMENTS

Various examples are described and illustrated herein to provide an overall understanding of the structure, function, and use of the disclosed fastening collars, multi-piece fasteners, pins, and methods of fastening. The various examples described and illustrated herein are non-limiting and non-exhaustive. Thus, the invention is not limited by the description of the various non-limiting and non-exhaustive examples disclosed herein. Rather, the invention is defined solely by the claims. The features and characteristics illustrated and/or described in connection with various examples may be combined with the features and characteristics of other examples. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. The various embodiments disclosed and described in this specification can comprise, consist of, or consist essentially of the features and characteristics as variously described herein.

As used herein, “intermediate” means that the referenced element is disposed between two elements but is not necessarily in contact with those elements. Accordingly, unless stated otherwise herein, an element that is “intermediate” a first element and a second element may or may not be adjacent to or in contact with the first and/or second elements, and other elements may be disposed between the intermediate element and the first and/or second elements.

During installation of a multi-piece fastener including a fastening collar into a structure, increasing the clamp force that the multi-piece fastener applies to the structure can be desirable in some applications. However, high clamp force values for certain applications, such as, where temperatures vary widely, can be undesirable. For example, during operation of an aerospace engine, high clamp force values exerted by an installed multi-piece fastener can vary widely dependent on the temperature, which can lead to variable performance of the multi-piece fastener. In some applications involving high temperatures, a high clamp force may not be achievable and/or may damage the underlying structure. Additionally, reducing the clamp force typically also reduces the tensile strength of the multi-piece fastener installed in the structure.

In light of these issues, the present inventors have provided fastening collars, multi-piece fasteners, and methods for fastening that can control a clamp force value during and/or after installation while achieving a desirable tensile strength of the multi-piece fastener.

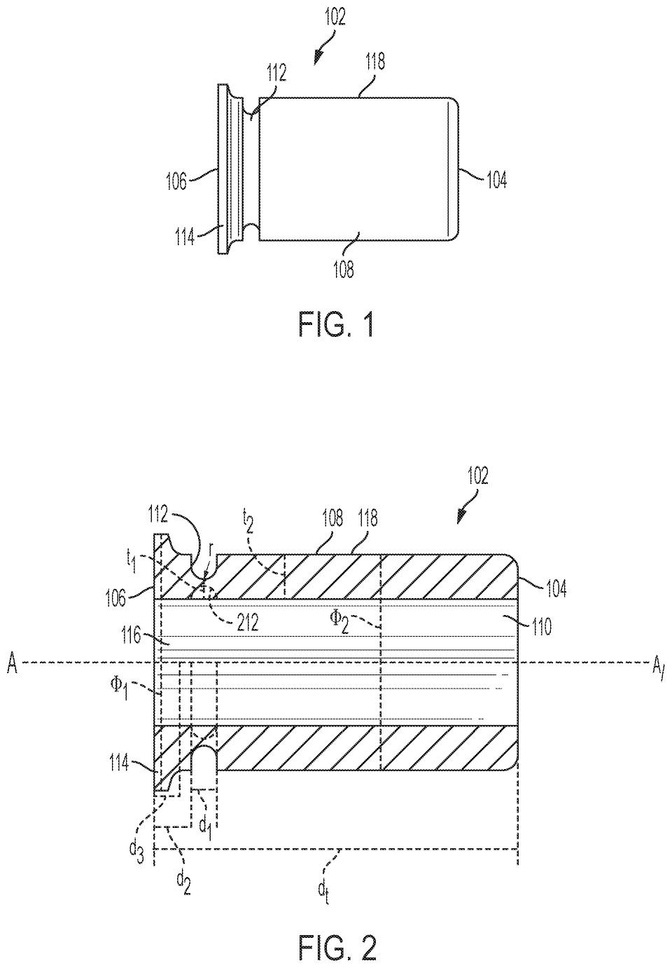

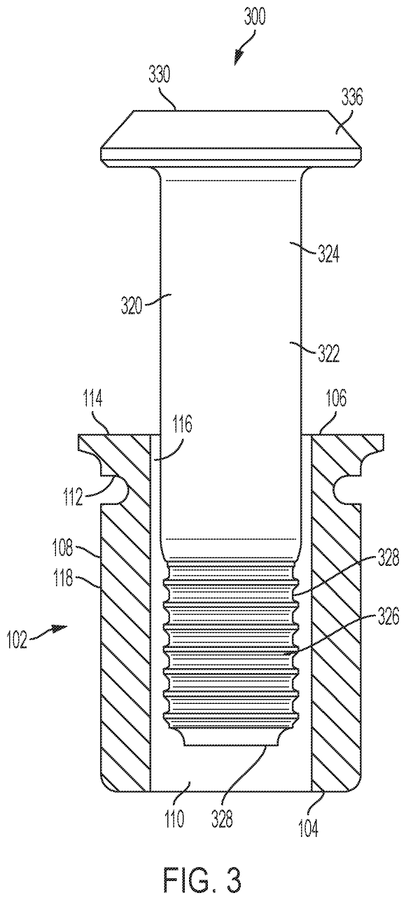

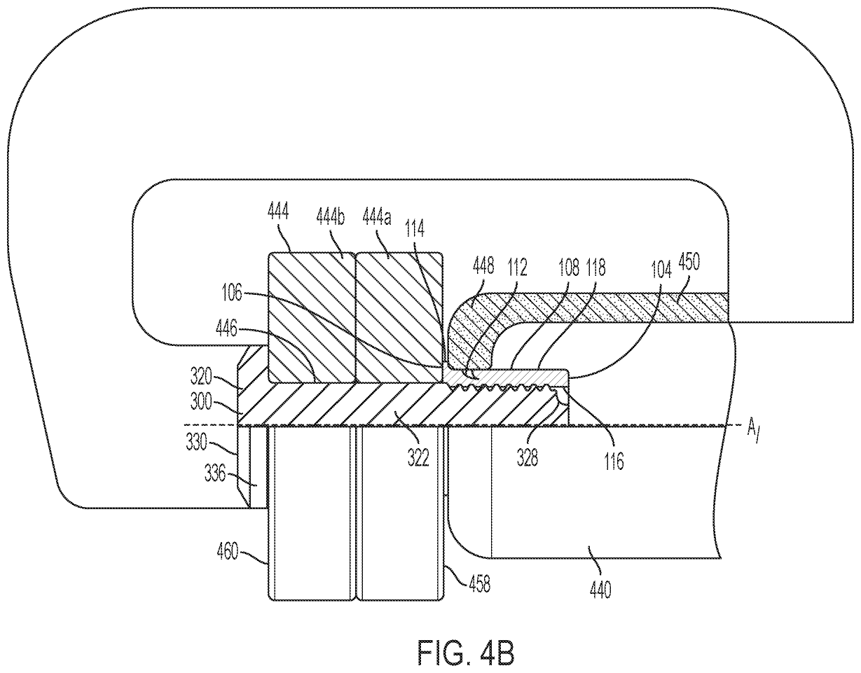

Referring to FIGS. 1-2, a non-limiting embodiment of a fastening collar 102 according to the present disclosure can comprise a first collar end 104, a second collar end 106, an elongate portion 108 intermediate the first collar end 104 and the second collar end 106, an inner collar surface 116, and an external collar surface 118. The elongate portion 108 can define a longitudinal axis, Aₗ, of the fastening collar 102. The inner collar surface 116 extends from the first collar end 104 to the second collar end 106. The inner collar surface 116 can define a collar cavity 110 that extends through the elongate portion 108 from the first collar end 104 to the second collar end 106. The elongate portion 108 can be configured to conform to a contact surface on a multi-piece fastener installation tool (e.g., multi-piece fastener installation tool 440 as described with respect to FIGS. 4A-4B).

The elongate portion 108 can comprise a groove on at least one of the external collar surface 118 and the inner collar surface 116. For example, as illustrated in FIGS. 1-2, a groove 112 is provided on the external collar surface 118. The groove 112 is an area of reduced wall thickness of elongate portion 108 such that clamping force generated by the fastening collar 102 during installation can be controlled, as further discussed below with reference to FIGS. 4A-4B. In certain embodiments, the wall thickness, t₁, of the elongate portion at the groove 112 can be at least 10% less than the average wall thickness, t₂, of the elongate portion 108, such as, for example, at least 20% less, at least 25% less, at least 30% less, at least 40%, or at least 50% less than the average wall thickness, t₂, of the elongate portion 108. For example, the elongate portion at the groove 112 can comprise a wall thickness that is in a range of 30% to 90% of the average wall thickness, t₂, of the elongate portion 108, such as, for example, 40% to 80%, 40% to 70%, or 50% to 75% of the average wall thickness, t₂, of the elongate portion 108.

The groove 112 extends a first distance, d₁, along the longitudinal axis, A₁. The first distance, d1, can be at least 2% of the total length, dₜ, of the fastening collar 102, as measured along the longitudinal axis, Aₗ, such as, for example, at least 5%, at least 10%, at least 12%, or at least 15% of the total length, dₜ, of the fastening collar 102. For example, the first distance, d₁, can be in a range of 2% to 30% of the total length, dₜ, of the fastening collar 102 as measured along the longitudinal axis, Aₗ, such as for example, 2% to 25%, 5% to 25%, 5% to 15%, or 5% to 20% of the total length, dₜ, of the fastening collar 102 as measured along the longitudinal axis, Aₗ. In various non-limiting embodiments, the first distance, d₁, can be in a range of 0.1 millimeter (mm) to 10 mm, such as, for example, 0.1 mm to 5 mm, 0.2 mm to 2.5 mm, 0.5 mm 10 to 4 mm, or 0.5 mm to 2 mm.

In certain embodiments, the groove 112 can be annular. In various non-limiting embodiments in which the groove is defined on at least the external collar surface 118, the groove 112 can extend around at least a portion of the outer circumference of the external collar surface 118, or in other embodiments can extend around the entire outer circumference of the 15 external collar surface 118. In certain non-limiting embodiments in which the groove 212 is defined on at least the inner collar surface 116, the groove 212 can extend around at least a portion of inner circumference of the of the inner collar surface 116, or in other embodiments can extend around the entire inner circumference of the inner collar surface 116.

The present inventor determined that reducing the average wall thickness, t₂, of the entire fastening collar 102 can reduce the force required to install the fastening collar 102, but this can also undesirably reduce the tensile strength of a multi-piece fastener including the fastening collar 102. The present inventor determined that adjusting the size and/or shape of groove 112 can adjust the force required to install the fastening collar 102 and/or the resulting clamp force applied to a structure while achieving a desirable tensile strength of the multi-piece fastener in a structure. Controlling clamp force generated by securing the fastening collar 102 while achieving a desirable tensile strength of the multi-piece fastener can improve the operational life of the multi-piece fastener. For example, the fastening collar 102 can be more resistant to clamp load changes due to temperature fluctuations than a conventional fastening collar and/or achieve an enhanced tensile strength during operation.

In certain non-limiting embodiments, the elongate portion 108 can comprise at least two grooves (not shown) or at least three grooves. The grooves may be the same or different. Individually, each groove or collectively all of the grooves can be configured according to groove 112. The grooves can be configured to adjust the force required to install the fastening collar 102 and/or the resulting clamp force applied to a structure while achieving a desirable tensile strength of the multi-piece fastener in a structure.

As illustrated in the embodiment shown in FIGS. 1-2, the groove 112 can comprise a cross-sectional shape of a half circle having a radius of curvature, r, that can be in a range of 0.1 mm to 10 mm, such as, for example, 0.1 mm to 5 mm, 0.2 mm to 2.5 mm, or 0.5 mm to 2 mm. In various other non-limiting embodiments, the groove 112 can comprise a different cross-sectional shape, such as, for example, a triangular shape, a rectangular shape, a different polygonal shape, and/or a curved shape.

The clamping force of a multi-piece fastener can be generated by urging material of the fastening collar 102 against the structure. The present inventor has determined that reducing the wall thickness of the elongate portion 108 at a region proximal to the structure, such as in the groove 112, can enable deformation and/or local compression into the groove 112 instead of generation of clamping force onto the structure. The groove 112 can be offset from the second collar end 106 by a second distance, d₂. The second distance, d₂, can be at least 5% of the total length, dₜ, of the fastening collar 102 as measured along the longitudinal axis, Aₗ, such as, for example, at least 10%, at least 15%, or at least 25% of the total length, dₜ, of the fastening collar 102. In certain non-limiting embodiments, the second distance, d₂, can be in a range of 5% to 50% of the total length, dₜ, of the fastening collar 102, such as, for example, 5% to 40%, 5% to 30%, or 5% to 25% of the total length, dₜ, of the fastening collar 102.

The elongate portion 108 can comprise a flange portion 114, which can extend a third distance, d₃, along the longitudinal axis, Aₗ. The third distance, d₃, can be at least 5% of the total length, dₜ, of the fastening collar 102 as measured along the longitudinal axis, Aₗ, such as, for example, at least 10%, at least 15%, or at least 25% of the total length, dₜ, of the fastening collar 102. In various non-limiting embodiments, the third distance, d₃, can be in a range of 0.1 mm to 10 mm, such as, for example, 0.1 mm to 5 mm, 0.2 mm to 2.5 mm, or 0.5 mm to 2 mm.

The flange portion 114 can inhibit the fastening collar 102 from entering a bore of a structure and/or increase surface area contact with a structure. For example, the flange portion 114 can comprise an outer diameter, Φ₁, that is greater than an average outer diameter, Φ₂, of the elongate portion 108, such as, for example, at least 5% greater, at least 10% greater, or at least 15% greater than an average outer diameter, Φ₂, of the elongate portion 108.

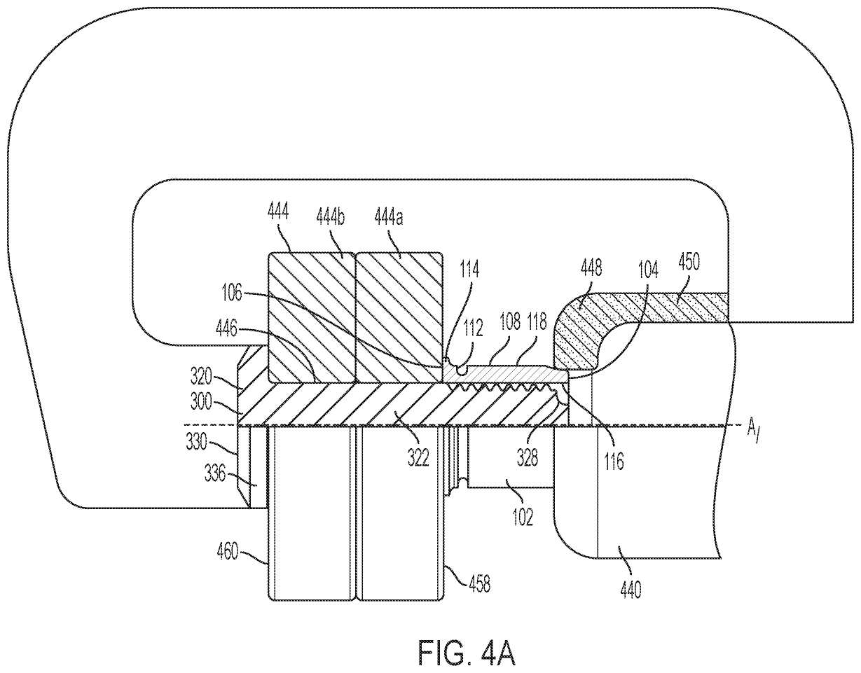

The collar cavity 110 of the elongate portion 108 can be configured to at least partially receive a pin of a multi-piece fastener, such as, for example, pin 320 of the multi-piece fastener 300 shown in FIG. 3. In other non-limiting embodiments (not shown), a multi-piece fastener according to the present disclosure can comprise three or more components. In various non-limiting embodiments, referring to FIG. 3, the multi-piece fastener 300 can consist of a two-piece assembly including, for example, the fastening collar 102 and the pin 320. In certain non-limiting embodiments, the multi-piece fastener 300 can comprise a lockbolt and/or a blind fastener. In certain non-limiting embodiments of the multi-piece fastener 300 including a lockbolt, the lockbolt can be a structural lockbolt fastener, such as, for example, a structural rivet, a structural bolt, or a structural stud.

Referring to FIG. 3, the pin 320 can comprise a first pin end 328, a second pin end 330, and a shank 322. The shank 322 can comprise a shape suitable to be received within the collar cavity 110 of the fastening collar 102. In various non-limiting embodiments, the shank 322 has a generally cylindrical shape. The shank 322 can be intermediate the first pin end 328 and the second pin end 330 and can be dimensioned so that the shank 322 can be inserted and extend at least partially into the collar cavity 110. When the shank 322 is inserted in the collar cavity 110, the first pin end 328 can be disposed adjacent to the first collar end 104, and a head portion 336 of the second pin end 330 can be disposed adjacent to the second collar end 106.

The collar cavity 110 of the fastening collar 102 can be configured to at least partially receive the shank 322 of the pin 320 therein. For example, the collar cavity 110 can comprise a shape suitable to receive the shank 322 of the pin 320. The fastening collar 102, including the inner collar surface 116, can be configured to be at least partially deformed onto the shank 322. For example, during and/or after introduction of the shank 322 into the collar cavity 110, the elongate portion 108, including at least a portion of the inner collar surface 116, can be at least partially deformed (e.g., swaged) onto the shank 322 responsive to forcible contact between the fastening collar 102 and a multi-piece fastener installation tool. Deformation of the elongate portion 108 can secure the fastening collar 102 to the shank 322 of the pin 320, securing the multi-piece fastener 300 within a bore in a structure.

In various non-limiting embodiments, the pin 320 may comprise a breakneck groove (not shown) configured to fracture to separate all or a portion of a pull region (not shown) from the pin 320 upon installation of the multi-piece fastener 300 in a bore in a structure. In certain other non-limiting embodiments, the pin 320 does not comprise a breakneck groove but is configured to include one or more other features so that the pull region of the pin 320 fractures during installation of the multi-piece fastener 300. In various non-limiting embodiments of the multi-piece fastener 300, the pin 320 does not comprise a breakneck groove or other feature configured to fracture upon installation of the multi-piece fastener 300, and the pull region remains intact after installation. Thus, various non-limiting embodiments of multi-piece fasteners according to the present disclosure may be installed in a structure without fracturing a breakneck groove or other feature or, alternatively, the fasteners may include a breakneck groove or other feature that fractures upon installation of the multi-piece fastener into the structure.

In various non-limiting embodiments, the second pin end 330 can further comprise the head portion 336 configured to inhibit the pin 320 from traversing into a bore in a structure beyond a predetermined distance. The shank 322 can comprise at least one of a generally smooth region, an annular shoulder, a groove, a thread, and/or one or more other features configured to engage the inner collar surface 116 of the fastening collar 102. For example, and as illustrated in FIG. 3, the shank can comprise a substantially smooth region 324 and a second region 326. The second region 326 comprise an annular shoulder, a groove, and/or a thread, such as, for example, grooves 328 illustrated in FIG. 3, configured to engage the inner collar surface 116.

The fastening collar 102 and/or the pin 320 can be sized to increase mechanical stability of the multi-piece fastener 300 after installation. For example, the substantially smooth region 324 and the groove 112 can be sized and configured on the shank 322 and the fastening collar 102, respectively, such that the groove 112 engages the substantially smooth region 324 during installation of the multi-piece fastener 300. In various non-limiting embodiments in which the groove 112 is positioned over the substantially smooth region 324 during installation, the multi-piece fastener 300 can have an enhanced mechanical stability compared to embodiments in which the groove 112 is positioned over the second region 326 during installation.

Additionally, the multi-piece fastener 100 can be sized as appropriate for the intended application. For example, in certain non-limiting embodiments the shank 322 can comprise a shank diameter in a range of 0.06 inch to 4 inches, and the fastening collar 102 can be sized to receive the shank 322.

In various non-limiting embodiments, the shank 322 can comprise a pull region configured to be engaged by a multi-piece fastener installation tool (not shown) when installing the multi-piece fastener 300 in a bore in a structure. The pull region can comprise an axial length, and in various non-limiting embodiments the pull region can comprise a taper. In various non-limiting embodiments, the pull region can comprise at least one of a generally smooth region, an annular shoulder, a groove, a thread, and/or one or more other features configured to be engaged by a multi-piece fastener installation tool. In certain non-limiting embodiments, the multi-piece fastener installation tool can be a puller tool or a squeezer tool.

The multi-piece fastener 300, including the fastening collar 102 and the pin 320, can comprise any suitable material, such as, for example, a metal, a metal alloy, a polymer, or another suitable material. For example, in various non-limiting embodiments, the multi-piece fastener 300 can comprise at least one of aluminum, an aluminum alloy, titanium, a titanium alloy, nickel, a nickel alloy, iron, an iron alloy, and a carbon fiber composite material.

As illustrated in the non-limiting embodiments shown in FIGS. 4A-4B, the multi-piece fastener 300 can be installed into a bore 446 in a structure 444. As illustrated, the bore 446 can extend through the structure 444 from a first side 458 to a second side 460 of the structure 444. The structure 444 can comprise, for example, at least one of a metal, a metal alloy, a composite material, or another suitable material. For example, in certain non-limiting embodiments, the structure 444 can comprise one or more of aluminum, an aluminum alloy, titanium, a titanium alloy, nickel, a nickel alloy, iron, an iron alloy, and a carbon fiber composite material. In various non-limiting embodiments, the structure 444 in which the multi-piece fastener 300 is installed comprises aluminum and/or an aluminum alloy, such as, for example, a 7075 aluminum alloy. In various non-limiting embodiments, the structure 444 into which a multi-piece fastener 300 can be installed can be configured as, or as a part or region of, at least one of an aerospace component or structure, an automotive component or structure, a transportation component or structure, a building and construction component or structure, or another component or structure.

The structure 444 can comprise a single layer of material or two or more layers of material. For example, as illustrated in FIGS. 4A-4B, the structure 444 can comprise a first layer 444a and a second layer 444b, which may be the same material or different materials. The first layer 444a can be positioned intermediate the second layer 444b and the fastening collar 102 when the multi-piece fastener 300 is installed. In various non-limiting embodiments, the first layer 444a is adjacent to or contacts the fastening collar 102.

Additionally, in various non-limiting embodiments, the first pin end 328 can be sized and configured to facilitate alignment of the pin 320 with the bore 446, thereby allowing the first pin end 328 to readily move into and through the bore 446. In various non-limiting embodiments, the head portion 336 can be sized and configured to inhibit the pin 320 from traversing into the bore 446 beyond a predetermined distance.

As illustrated in FIG. 4A, the first pin end 328 of the pin 320 was positioned in alignment with the second side 460 of the bore 446 and inserted through the bore 446. The fastening collar 102 was then positioned over the first pin end 328, and the first pin end 328 was inserted into and through the collar cavity 110 of the fastening collar 102. In the arrangement shown in FIG. 4A, the fastening collar 102 has not yet been deformed about the pin 320.

With reference to FIG. 4A, and as will be understood by those having ordinary skill in the multi-piece fastener art considering the present disclosure, the multi-piece fastener installation tool 440 can close around and forcibly engage the head portion 336 of the pin 320 and the fastening collar 102. The multi-piece fastener installation tool 440 can apply a clamp force urging the head portion 336 towards the fastening collar 102 and the fastening collar 102 towards the head portion 336. As the clamp force is applied, an anvil 448 of the multi-piece fastener installation tool 440 can forcibly contact the fastening collar 102 with an axial force and urge the fastening collar 102 along the pin 320 in a direction away from the first pin end 328. The movement of the fastening collar 102 can decrease the width of a gap, if present, between the first layer 444a and the second layer 444b of the structure 444 and forcibly contact the fastening collar 102 with the structure 444.

As illustrated in FIG. 4A, the anvil 448 has engaged the elongate portion 108, and the second collar end 106 of the fastening collar 102 has engaged the first side 458 of the structure 444. Referring to FIG. 4B, when the anvil 448 of the multi-piece fastener installation tool 440 imparts a sufficient force to the fastening collar 102, the elongate portion 108 is at least partially deformed (e.g., swaged) onto the pin 320. For example, the inner collar surface 116 can be deformed onto the shank 322 of the pin 320 intermediate the first layer 444a and the first pin end 328. The deformation of the elongate portion 108 can secure the fastening collar 102 to the pin 320 and thereby secure the multi-piece fastener 300 to at least a portion of the structure 444. In that way, for example, the first layer 444a and the second layer 444b of the structure 444 are secured together. After installation of the multi-piece fastener 300 into the structure 444, the fastening collar 102 and the head portion 336 of the pin 320 are applying a clamp force to the structure 444.

The groove 112 can be deformed after installation and change shape. For example, the groove 112 can be compressed locally as illustrated in FIG. 4B and be reduced in size compared to the groove in FIG. 4A prior to installation. The material from the elongate portion 108 of the fastening collar 102 can be urged into the groove 112 such that the clamp force applied to the structure 444 can be reduced compared to a similar fastening collar without the groove 112. In various non-limiting embodiments, the clamp force to install the multi-piece fastener 300 can be reduced by at least 10% compared to a similar fastening collar without the groove 112, such as, for example, reduced by at least 15%, reduced by at least 20%, reduced by at least 25%, or reduced by at least 30% compared to a similar fastening collar without the groove 112. The size and/or location of the groove 112 can be adjusted to achieve a desired clamping force.

The multi-piece fastener 300 can achieve a desirable ultimate tensile strength because the reduced wall thickness of the fastening collar 102 is locally maintained to the groove 112.

In various non-limiting embodiments, after installation, the multi-piece fastener can exhibit an ultimate tensile strength of at least 500 dekanewtons (daN), such as, for example, at least 600 daN, at least 700 daN, at least 800 daN, at least 900 daN, or at least 1,000 daN.

As illustrated in FIG. 4B, the pin 320 may not fracture after installation into the structure 444. Alternatively, the pin 320 may fracture (not shown) after installation into the structure 444 as a result of force applied to the pin 320 by a multi-piece fastener installation tool configured as a puller tool. For example, the pin 320 may fracture along a breakneck groove, if present, after installation into the structure 444.

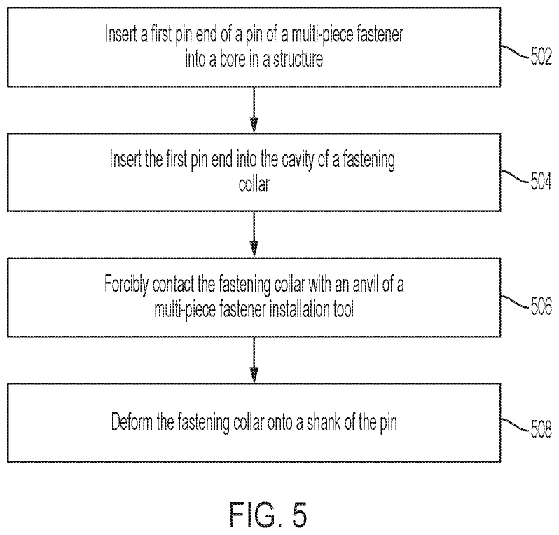

Embodiments of multi-piece fasteners according to the present disclosure can be used in a method for fastening a structure. FIG. 5 illustrates steps of a non-limiting embodiment of such a method. The method illustrated in FIG. 5 can comprise inserting the first pin end 328 of a multi-piece fastener 300 according to the present disclosure into a bore 446 in a structure 444 (at step 502). After inserting the first pin end 328 into the structure 444, the first pin end 328 can be inserted into the collar cavity 110 of the fastening collar 102 (at step 504). Subsequent to inserting the first pin end 328 into the collar cavity 110, in certain non-limiting embodiments, the fastening collar 102 can be forcibly contacted with an anvil 448 of a multi-piece fastener installation tool 440, urging the fastening collar 102 to move along the pin 320 in a direction away from the first pin end 328 (at step 506). The inner collar surface 116 of the fastening collar 102 can be deformed onto the shank 322 of the pin 320, thereby securing the pin 320 to the fastening collar 102 and retaining at least a portion of the multi-piece fastener 300 in the structure 444 (at step 508). Deforming the elongate portion 108 can include deforming the groove 112 such that the groove 112 can change shape.

Various aspects of non-limiting embodiments of inventions according to the present disclosure include, but are not limited to, the aspects listed in the following numbered clauses.
Clause 1. A fastening collar comprising:
   a first collar end;
   a second collar end; and
   an elongate portion intermediate the first collar end and the second collar end and defining a longitudinal axis of the fastening collar, wherein the elongate portion comprises:
      an external collar surface;
      an inner collar surface defining a collar cavity; and
      a groove on at least one of the external collar surface and inner collar surface,
   wherein the groove extends a first distance along the longitudinal axis.
Clause 2. The fastening collar of clause 1, wherein the groove is on at least the external collar surface of the elongate portion.
Clause 3. The fastening collar of any of clauses 1-2, wherein the groove is on at least the inner collar surface of the elongate portion
Clause 4. The fastening collar of any of clauses 1-3, wherein a wall thickness of the elongate portion at the groove is at least 10% less than an average wall thickness of the elongate portion.
Clause 5. The fastening collar of any of clauses 1-3, wherein a wall thickness of the elongate portion at the groove is at least 20% less than an average wall thickness of the elongate portion.
Clause 6. The fastening collar of any of clauses 1-5, wherein the groove is annular.
Clause 7. The fastening collar of any of clauses 1-6, wherein the first distance is at least 5% of the total length of the fastening collar.
Clause 8. The fastening collar of any of clauses 1-7, wherein the groove is offset at least 5% of the total length of the fastening collar from the second collar end.
Clause 9. The fastening collar of any of clauses 1-8, wherein the elongate portion further comprises a flange portion extending a second distance along the longitudinal axis.
Clause 10. The fastening collar of any of clauses 1-9, wherein the fastening collar is generally cylindrical.
Clause 11. The fastening collar of any of clauses 1-10, wherein the fastening collar comprises at least one of a metal, a metal alloy, and a composite.
Clause 12. A multi-piece fastener comprising:
   the fastening collar of any of clauses 1-11; and
   a pin configured to be at least partially received in the collar cavity of the fastening collar.
Clause 13. The multi-piece fastener of clause 12, wherein the groove is configured to engage a substantially smooth region of a shank of the pin during installation.
Clause 14. The multi-piece fastener of any of clauses 12-13, wherein the pin comprises a shank comprising at least one of an annular shoulder, a groove, a threaded region, and a substantially smooth region.
Clause 15. The multi-piece fastener of any of clauses 12-14, wherein the multi-piece fastener is configured to be installed in a bore in a structure configured as at least one of an aerospace part or component, an automotive part or component, a transportation part or component, and a building and construction part or component.
Clause 16. The multi-piece fastener of any of clauses 12-15, wherein the pin comprises a shank comprising a shank diameter in a range of 0.06 inch to 4 inches.
Clause 17. The multi-piece fastener of any of clauses 12-16, wherein the pin further comprises a head portion.
Clause 18. The multi-piece fastener of any of clauses 12-17, wherein the multi-piece fastener is at least one of a lockbolt and a blind fastener.
Clause 19. A method for fastening, the method comprising:
   providing a multi-piece fastener comprising
      a fastening collar according to any of clauses 1-11, and
      a pin configured to be at least partially received in the collar cavity of the fastening collar, wherein the pin comprises
         a shank comprising a generally smooth region, and
         a second region comprising at least one of an annular shoulder, a groove, and a threaded region;
   inserting the first pin end of the pin into a bore of a structure and the collar cavity, wherein the groove is positioned over the generally smooth region; and
   forcibly contacting the elongate portion of the fastening collar with a contact surface of an installation tool, thereby forcibly contacting the structure with the second collar end of the fastening collar and deforming the elongate portion onto the shank of the pin, including deforming the groove onto the generally smooth region of the shank.
Clause 20. The method of clause 19, wherein deforming the elongate portion onto the shank comprises swaging with an anvil of the installation tool.

One skilled in the art will recognize that the fastening collars, multi-piece fasteners, structures, methods, operations/actions, and objects described herein, and the accompanying discussion, are non-limiting examples presented for the sake of conceptual clarity and that various modifications to the disclosed configurations are contemplated. Consequently, as used herein, the specific examples/embodiments set forth, and the accompanying discussion, are intended to be representative of their more general classes. In general, use of any specific exemplar is intended to be representative of its class and the non-inclusion of specific components, devices, apparatus, operations/actions, and objects should not be taken as limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

Any references herein to “various embodiments”, “some embodiments”, “one embodiment”, “an embodiment”, a “non-limiting embodiment”, or like phrases mean that a particular feature, structure, or characteristic described in connection with the example is included in at least one embodiment. Thus, appearances of the phrases “in various embodiments”, “in some embodiments”, “in one embodiment”, “in an embodiment”, “in a non-limiting embodiment”, or like phrases in the specification do not necessarily refer to the same embodiment. Furthermore, the particular described features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation. Such modifications and variations are intended to be included within the scope of the present embodiments.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

The grammatical articles “a”, “an”, and “the”, as used herein, are intended to include “at least one” or “one or more”, unless otherwise indicated, even if “at least one” or “one or more” is expressly used in certain instances. Thus, the foregoing grammatical articles are used herein to refer to one or more than one (i.e., to “at least one”) of the particular identified elements. Further, the use of a singular noun includes the plural, and the use of a plural noun includes the singular, unless the context of the usage requires otherwise.

1. A multi-piece fastener comprising
a pin configured to be at least partially received in the collar cavity of the fastening collar; and
a fastening collar comprising:
a first collar end;
a second collar end; and
an elongate portion intermediate the first collar end and the second collar end and defining a longitudinal axis of the fastening collar, wherein the elongate portion comprises
an external collar surface,
an inner collar surface defining a collar cavity, and
a groove on at least one of the external collar surface and the inner collar surface, wherein the groove extends a first distance along the longitudinal axis, and wherein the groove is configured to engage a substantially smooth region of a shank of the pin during installation.

2. The multi-piece fastener of claim 1, wherein the groove is on at least the external collar surface of the elongate portion.

3. The multi-piece fastener of claim 1, wherein the groove is on at least the inner collar surface of the elongate portion

4. The multi-piece fastener of claim 1, wherein a wall thickness of the elongate portion at the groove is at least 10% less than an average wall thickness of the elongate portion.

5. The multi-piece fastener of claim 1, wherein a wall thickness of the elongate portion at the groove is at least 20% less than an average wall thickness of the elongate portion.

6. The multi-piece fastener of claim 1, wherein the groove is annular.

7. The multi-piece fastener of claim 1, wherein the first distance is at least 5% of the total length of the fastening collar.

8. The multi-piece fastener of claim 1, wherein the groove is offset at least 5% of the total length of the fastening collar from the second collar end.

9. The multi-piece fastener of claim 1, wherein the elongate portion further comprises a flange portion extending a second distance along the longitudinal axis.

10. The multi-piece fastener of claim 1, wherein the fastening collar is generally cylindrical.

11. The multi-piece fastener of claim 1, wherein the fastening collar comprises at least one of a metal, a metal alloy, and a composite.

12. (canceled)

13. (canceled)

14. The multi-piece fastener of claim 1, wherein the pin comprises a shank comprising at least one of an annular shoulder, a groove, a threaded region, and a substantially smooth region.

15. The multi-piece fastener of claim 1, wherein the multi-piece fastener is configured to be installed in a bore in a structure configured as at least one of an aerospace part or component, an automotive part or component, a transportation part or component, and a building and construction part or component.

16. The multi-piece fastener of claim 1, wherein the pin comprises a shank comprising a shank diameter in a range of 0.06 inch to 4 inches.

17. The multi-piece fastener of claim 1, wherein the pin further comprises a head portion.

18. The multi-piece fastener of claim 1, wherein the multi-piece fastener is at least one of a lockbolt and a blind fastener.

19. A method for fastening, the method comprising:
providing a multi-piece fastener comprising
a fastening collar comprising
a first collar end,
a second collar end, and
an elongate portion intermediate the first collar end and the second collar end and defining a longitudinal axis of the fastening collar, wherein the elongate portion comprises
an external collar surface,
an inner collar surface defining a collar cavity, and
a groove on at least one of the external collar surface and the inner collar surface, wherein the groove extends a first distance along the longitudinal axis, and
a pin configured to be at least partially received in the collar cavity of the fastening collar, the pin comprises a shank comprising
a generally smooth region, and
a second region comprising at least one of an annular shoulder, a groove, and a threaded region;
inserting the first pin end of the pin into a bore of a structure and the collar cavity, wherein the groove is positioned over the generally smooth region; and
forcibly contacting the elongate portion of the fastening collar with a contact surface of an installation tool, thereby forcibly contacting the structure with the second collar end of the fastening collar and deforming the elongate portion onto the shank of the pin, including deforming the groove.

20. The method of claim 19, wherein deforming the elongate portion onto the shank comprises swaging with an anvil of the installation tool.
